(19) United States
(12) Patent Application Publication
(10) Pub. No.: US 2013/0002929 A1
(43) Pub. Date: Jan. 3, 2013

(54) DATA RECORDING CONTROL DEVICE AND DATA RECORDING DEVICE

(75) Inventor: Hitoshi SAKAMOTO, Yokohama-shi, (JP)

(73) Assignee: NIFCO INC., Yokohama-shi (JP)

(21) Appl. No.: 13/527,159

(22) Filed: Jun. 19, 2012

(30) Foreign Application Priority Data
Jun. 28, 2011 (JP) 2011-143043

(51) Int. Cl. H04N 5/225

(52) U.S. Cl. 348/335; 348/E05.024

(57) ABSTRACT

A data recording control device controls a recording device to record data acquired by a data acquisition device from a first time point before inputting a trigger signal to a second time point after the trigger signal is input, to a record medium. The control device has a sensor for detecting a light; an output portion for outputting the trigger signal in correspondence to the sensor detecting the light with a predetermined amount of lighting or above when the output portion is set in a standby state; and a control portion releasing the standby state when the output portion outputs the trigger signal, and setting the output portion in the standby state in correspondence to the sensor not detecting the light with the predetermined amount of lighting or above within a predetermined period of time.

### BACKGROUND OF THE INVENTION AND RELATED ART STATEMENT

The present invention relates to a data recording control device and a data recording device.

In order to identify a cause of abnormality which has occurred in an operation of a machine such as a molding machine and the like, a moving picture image of an operation state when the abnormality thereof has occurred is useful.

In patent document 1, there is disclosed a technology for generating a trigger signal by detecting the occurrence of an abnormal event using one of a sound sensor, an optical sensor, a pneumatic sensor, or a combination of those, and taking a photograph at a set time by a video camera. Then, in the patent document 1, there is disclosed that the aforementioned optical sensor is provided near a signal tower lighting up at a time of the abnormality in facilities which become a monitoring subject.

### PRIOR ART DOCUMENTS

Patent Document 1: Japanese Patent Publication No. 2000-41237

There are many cases where the signal tower carries out a blinking operation in order to inform an observer of the occurrence of the abnormality more reliably.

When an output of the optical sensor provided near the signal tower carrying out such blinking operation is used as the trigger signal, the start-up of a video recording operation is repeated in a short-term cycle, so that there has been a possibility that a condition of the occurrence of the abnormality cannot be correctly recorded.

An object of the present invention is to appropriately record data representing a condition at a time of the occurrence of the abnormality in equipment, which becomes the monitoring subject, while acquiring a trigger based on a lighting-up state of the signal tower carrying out the blinking operation.

Further objects and advantages of the invention will be apparent from the following description of the invention.

### SUMMARY OF THE INVENTION

In order to solve the above-mentioned problems and achieve the object, a data recording control device of the present invention is structured as follows.

As one aspect of the present invention, the data recording control device controls a recording device which records data in a record medium, in which a data acquisition device has acquired between a time point prior to a first time period before a trigger signal is input, and a time point subsequent to a second time period after the trigger signal has been input. When an output portion is set in a standby state, the output portion outputs the trigger signal on condition that a light with a defined amount of light or above has been detected by a sensor. A control portion releases the standby state when the output portion has output the trigger signal, and sets the output portion in the standby state on a condition that a light with the defined amount of light or above has not been detected by the sensor within a certain period of time.

According to the present invention, while acquiring the trigger based on the lighting-up state of the signal tower carrying out the blinking operation, the data representing the condition at the time of the occurrence of the abnormality in the equipment which becomes the monitoring subject can be appropriately recorded.

### BRIEF DESCRIPTION OF THE DRAWINGS

FIG. 1 is a drawing showing an exterior appearance of a data recording device according to one embodiment;

FIG. 2 is a perspective view showing a mounting example of a sensor unit on a signal tower;

FIG. 3 is a structural view of an electric circuit wherein the data recording device is provided; and

FIG. 4 is a flow chart of a controller.

### DETAILED DESCRIPTION OF PREFERRED EMBODIMENTS

Hereinafter, a data recording device 100 according to one embodiment of the present invention will be explained with reference to FIGS. 1 to 4.

FIG. 1 is a drawing showing an exterior appearance of the data recording device 100.

The data recording device 100 includes a control box 1, a magnet base 2, a camera unit 3, a flexible arm 4, a sensor unit 5, and a power supply adapter 6.

The control box 1 includes an enclosure la, and the after-mentioned electric circuit is housed in the enclosure 1a. Incidentally, in the aforementioned electric circuit, there include a power switch 10 and a power lamp 11, and one portion of the power switch 10 and the power lamp 11 are exposed to an outside of the enclosure 1a.

The magnet base 2 is fixed to the control box 1. The magnet base 2 embeds a magnet. The magnet base 2 can turn on and off a magnetic force according to a direction of a knob 20, and is detachable relative to metal. Thus, the magnet base 2 functions as an attachment tool.

The camera unit 3 takes a moving picture, and saves moving picture data which represents the moving picture thereof.

The flexible arm 4 has a slender bar shape, one end is fixed to the control box 1, and the camera unit 3 is attached to the other end. The flexible arm 4 can be freely bent by a force from the outside. However, the flexible arm 4 has a withstand load larger than a weight of the camera unit 3. Thus, the flexible arm 4 functions as a support tool.

The sensor unit 5 includes an illumination intensity sensor 50, a light-blocking member 51, a band 52, and a cable 53.

The illumination intensity sensor 50 outputs a detecting signal with a level according to an illumination intensity of an incident light.

The light-blocking member 51 is made of a material with a light-blocking property, and includes a concave portion for holding the illumination intensity sensor 50. The light-blocking member 51 holds the illumination intensity sensor 50 by the aforementioned concave portion, and also blocks the incident light into the illumination intensity sensor 50 from a lateral side of the illumination intensity sensor 50. As for the light-blocking member 51, for example, a black rubber band can be used.

In the band 52, the light-blocking member 51 is fixed in an intermediate portion by, for example, being screwed and the like. Both ends of the band 52 can be mutually connected. For the band 52, for example, a surface fastener is suitable. The band 52 has a length in which both ends can be mutually connected in a state wherein the band 52 is wrapped around a signal tower.

The cable 53 transmits the detecting signal in which the illumination intensity sensor 50 outputs to the control box 1.

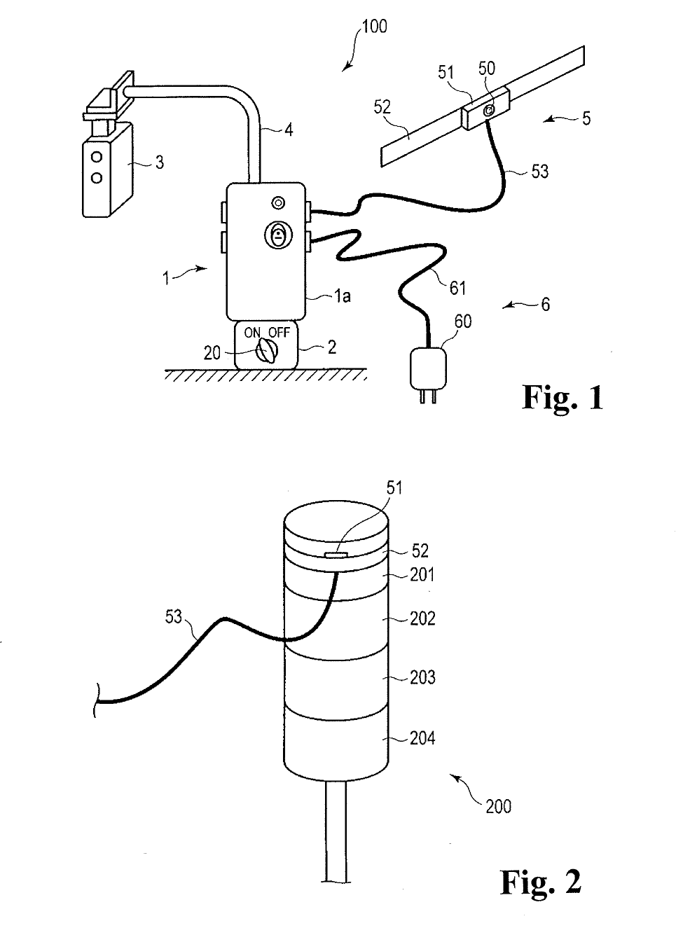

FIG. 2 is a perspective view showing a mounting example of the sensor unit 5 on a signal tower 200. Incidentally, in FIGS. 1 and 2, the same symbols are assigned to the same elements.

The signal tower 200 has a structure wherein respective cylindrical four light-emitting portions 201, 202, 203, and 204 are lined up in a line. Emission colors of the light-emitting portions 201, 202, 203, and 204 respectively differ. For example, the emission colors of the light-emitting portions 201, 202, 203, and 204 are respectively red, orange, yellow, and green. In the signal tower 200, in a case where an operation of a certain equipment (hereinafter, called a monitoring subject equipment) is abnormal, the light-emitting portion 201 blinks.

In a state wherein the illumination intensity sensor 50 faces the light-emitting portion 201, the band 52 is wrapped around the light-emitting portion 201, and further, both ends of the band 52 are mutually connected, so that the sensor unit 5 is attached to the signal tower 200. Thus, the band 52 functions as a fixture tool.

The power supply adapter 6 includes a main body 60 and a cable 61.

The main body 60 doubles with a plug binding to an outlet for an alternating-current source such as, for example, a commercial power supply and the like. The main body 60 is connected to the control box 1 by the cable 61.

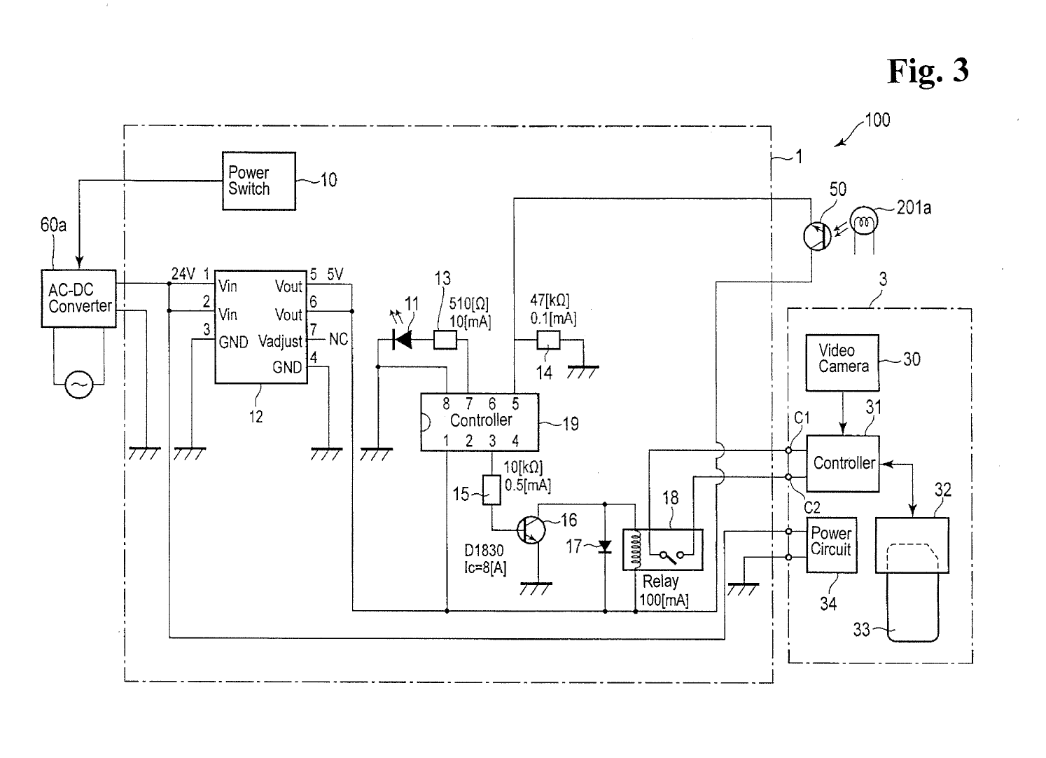

FIG. 3 is a structural view of the electric circuit wherein the data recording device 100 is provided. Incidentally, in FIGS. 1 and 3, the same symbols are assigned to the same elements.

In the main body 60 of the power supply adapter 6, there is embedded an AC-DC converter 60a. The AC-DC converter 60a converts an alternating-current power, which has been acquired by the alternating-current source, into a direct-current power with a predetermined primary voltage (for example, 24 V). The direct-current power which has been acquired at the AC-DC converter 60a is supplied to the control box 1 through the cable 61. An operation of the AC-DC converter 60a is turned on and off by the power switch 10.

Along with the power switch 10 and the power lamp 11, the control box 1 includes a DC-DC converter 12; resistors 13, 14, and 15; a transistor 16; a diode 17; a relay 18; and a controller 19.

The power lamp 11 is driven by a driving signal supplied through the resistor 13 from the controller 19, and emits light. As for the power lamp 11, for example, a green light-emitting diode can be used.

The DC-DC converter 12 acquires the direct-current power of 5 V from an electric power which has been supplied from the AC-DC converter 60A. The direct-current power of 5 V is used in order to operate the relay 18, the controller 19, and the illumination intensity sensor 50.

The resistor 13 is inserted between a seventh terminal of the controller 19 and the power lamp 11. The resistor 13 works as a load resistance in order for the controller 19 to drive the power lamp 11.

The resistor 14 works as a partial pressure resistance for supplying a voltage according to a level of the detecting signal wherein the illumination intensity sensor 50 outputs to a fifth terminal of the controller 19. Incidentally, a lamp 201a is a light-emitting source of the light-emitting portion 201 of the signal tower 200.

The resistor 15 is inserted between a third terminal of the controller 19 and a base terminal of the transistor 16. The resistor 15 functions as a load resistance in order for the controller 19 to control the transistor 16 to be turned on and off.

The transistor 16 turns on and off a power distribution to the relay 18 under the control of the controller 19.

The diode 17 maintains the relay 18 in a non-power-distribution state when the transistor 16 is off.

The relay 18 short-circuits between trigger contact points C1 and C2 provided in the camera unit 3 when the power distribution to the relay 18 is turned on by the transistor 16.

As mentioned hereinafter, in the camera unit 3, a state of short-circuiting between the trigger contact points C1 and C2 is addressed as a state wherein the trigger signal has been input. Thus, the resistor 15, the transistor 16, the diode 17, and the relay 18 comprise a generated circuit of the trigger signal.

The controller 19 is actualized by allowing, for example, a computer to accomplish a program in which the after-mentioned processing has been described. The controller 19 controls an operation of the camera unit 3 based on a detecting condition of the illumination intensity sensor 50 as mentioned hereinafter.

The camera unit 3 includes a video camera 30, a controller 31, a card connector 32, a memory card 33, and a power circuit 34.

The video camera 30 takes the moving picture, and outputs the moving picture data.

The controller 31 embeds a memory, and constantly stores the moving picture data (hereinafter, called previous data) in which the video camera 30 has output within a time frame up to the present point of time from a point of time going back to a primary time. In a case of short-circuiting between the trigger contact points C1 and C2 for more than a specified time, the controller 31 recognizes that the trigger signal has been input, and writes the previous data which has been memorized at that point thereof, and the moving picture data (hereinafter, subsequent data) in which the video camera 30 outputs within a time frame up to the time when a second time passes from that point thereof, into the memory card 33. Although the primary time and the second time may be respectively set arbitrarily, both are set in, for example, ten seconds.

The card connector 32 detachably holds the memory card 33, and also electrically connects the mounted memory card 33 and the controller 31.

The memory card 33 houses a semiconductor memory in a card-type enclosure. As for the memory card 33, various ready-made memory cards such as, for example, an SD memory card and the like can be used.

The direct-current power of 24 V which has been acquired at the AC-DC converter 60a is supplied to the power circuit 34 through the control box 1. The power circuit 34 supplies the direct-current power of 24 V to the video camera 30 and the controller 31 directly or by accordingly transforming the volt.

Incidentally, as for the camera unit 3, a ready-made drive recorder, a security picture recorder, and the like can be directly used.

Next, an operation of the data recording device 100 structured as mentioned above will be explained.

Regarding installation of the data recording device 100, first, an administrator contacts the magnet base 2 with a metal portion of the monitoring subject equipment or the metal portion around the monitoring subject equipment in a state wherein the knob 20 of the magnet base 2 faces the “off”. Then, in that state, when the administrator faces the knob 20 to the “on”, the magnet base 2 is magnetically attached to the metal portion. Thereby, the data recording device 100 is attached to the metal portion of the monitoring subject equipment or the metal portion around the monitoring subject equipment. After that, the administrator accordingly bends the flexible arm 4, and faces a photographing direction of the camera unit 3 to the monitoring subject equipment. Also, as shown in FIG. 2, and also in the aforementioned manner, the administrator mounts the sensor unit 5 on the signal tower 200 for displaying an operation state of the monitoring subject equipment. After that, the administrator turns the power switch 10 on.

When the power switch 10 is turned on, the AC-DC converter 60a is activated, and the direct-current power of 24 V is supplied to the control box 1 from the AC-DC converter 60a. The direct-current power is also supplied to the camera unit 3 through the control box 1. Thus, the camera unit 3 is activated so as to conduct a recording operation of the previous data.

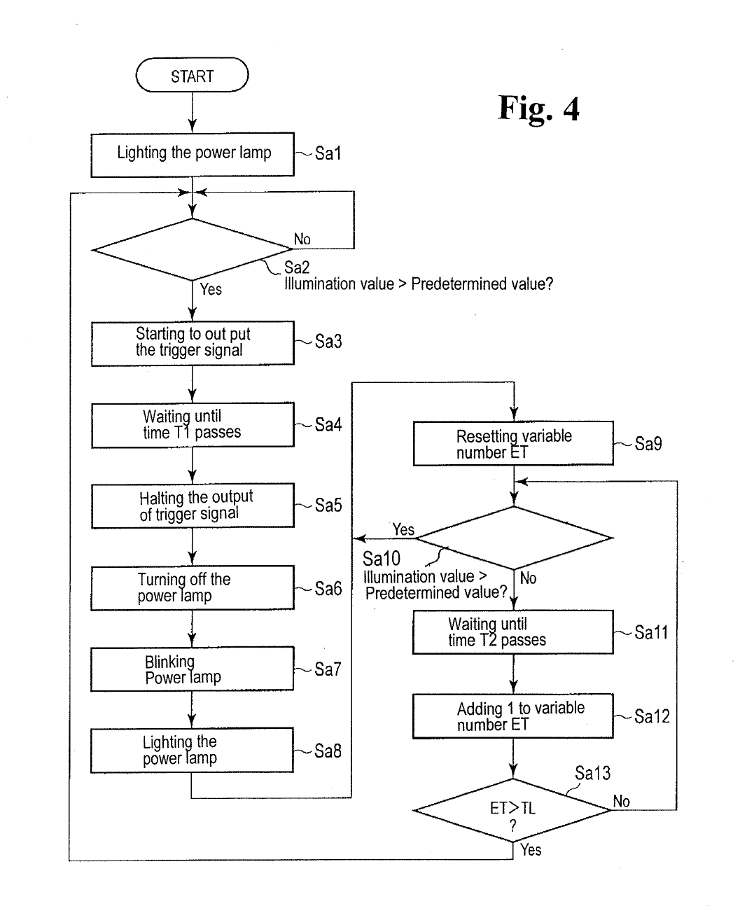

The direct-current power of 24 V is converted to the direct-current power of 5 V by the DC-DC converter 12, and the direct-current power of 5 V is supplied to the controller 19 and the illumination intensity sensor 50. Thus, the illumination intensity sensor 50 comes to output the detecting signal with the level according to the illumination intensity of the incident light. Also, the controller 19 starts the processing as shown in FIG. 4.

FIG. 4 is a flow chart of the processing of the controller 19.

In Step Sa1, the controller 19 lights up the power lamp 11.

In Step Sa2, the controller 19 waits for the illumination intensity which has been detected by the illumination intensity sensor 50 to become larger than a predetermined threshold value. Incidentally, the threshold value is determined in an intermediate value of the illumination intensity wherein the illumination intensity sensor 50 detects, respectively, when a light in which the lamp 201a has emitted does not enter into the illumination intensity sensor 50, and when the light in which the lamp 201a has emitted enters into the illumination intensity sensor 50.

Now, when an abnormality occurs in the monitoring subject equipment, and the abnormality thereof is detected by a separate monitoring device from the data recording device 100, the lamp 201a blinks in order for the light-emitting portion 201 of the signal tower 200 to blink. Alternatively, there is also a case wherein the lamp 201a is lit up, and also wherein a reflecting mirror, which changes an outgoing direction of the light in which the lamp 201a emits, is rotated.

Due to the aforementioned operation, when the light in which the lamp 201a has emitted enters into the illumination intensity sensor 50, the illumination intensity which has been detected by the illumination intensity sensor 50 becomes larger than the threshold value. There, in that case, the controller 19 moves on to Step Sa3 from Step Sa2.

In Step Sa3, the controller 19 starts to output the trigger signal by turning the transistor 16 on.

In Step Sa4, the controller 19 is in standby until a predetermined time T1 passes.

In Step Sa5, the controller 19 halts the output of the trigger signal by turning the transistor 16 off.

By the aforementioned processing of Step Sa2 to Step Sa5, during a period in which the controller 19 waits for the lighting-up of the lamp 201a, and in which the time T1 passes from a point of time in which the lamp 201a has lit up, the operation in which the trigger signal supplies to the camera unit 3 is actualized or made. This is the operation in the standby state, and an output portion is actualized or made by the processing of the controller 19 in Step Sa2 to Step Sa5; the resistor 15; the transistor 16; the diode 17; the relay 18; and the controller 19. In the camera unit 3, if the controller 31 has recognized the input of the trigger signal, the recording operation for writing the previous data and the subsequent data regarding a point of time thereof into the memory card 33 starts. Thus, the video camera 30 functions as data acquisition means, and also the memory card 33 functions as a memory medium, respectively.

In Step Sa6, the controller 19 turns off the power lamp 11.

In Step Sa7, the controller 19 blinks the power lamp 11 for a certain period of time (for example, for one second).

In Step Sa8, the controller 19 lights up the power lamp 11.

The start-up of the aforementioned recording operation relative to the camera unit 3 by the aforementioned processing of Step Sa6 to Step Sa8 is displayed by the temporary blinking of the power lamp 11.

In Step Sa9, the controller 19 resets a variable number ET in zero.

In Step Sa10, the controller 19 confirms whether or not the illumination intensity which has been detected by the illumination intensity sensor 50 is larger than the threshold value. Then, at that time, if the controller 19 determines as Yes, the controller 19 returns to Step Sa9 from Step Sa10. However, at that time, if the controller 19 determines as No, the controller 19 moves on to Step Sa11 from Step Sa10.

In Step Sa11, the controller 19 is in standby for a predetermined time T2. The time T2 is a cycle of confirming whether or not the blinking of the lamp 201a is continuing, and is set shorter than a blinking cycle of the lamp 201a.

In Step Sa12, the controller 19 adds one to the variable number ET.

In Step Sa13, the controller 19 confirms whether or not the variable number ET is larger than a specified value TL. Then, at that time, if the controller 19 determines as No, the controller 19 returns to Step Sa10 from Step Sa13. Also, at that time, if the controller 19 determines as Yes, the controller 19 returns to Step Sa2.

By a loop of Step Sa9 to Step Sa 13 as mentioned above, a timeframe, in which the lighting-up of the lamp 201a is not detected, waits for a time which exceeds a time determined as T2×TL. Incidentally, for example, if T2 is 8 m/sec, and TL is 250, there are approximately three seconds to wait for a condition in which the lighting-up of the lamp 201a is not detected to occur. Then, in that timeframe, even if the lighting-up of the lamp 201a is detected, the output of the trigger signal is not carried out. Namely, in that timeframe, the standby state is released. Then, if a state, in which the lighting-up of the lamp 201a is not detected by exceeding the time determined as T2×TL, has continued, the standby state is set. Thus, the processing of Step Sa9 to Step Sa13 is carried out, so that the controller 19 functions as a control portion.

As mentioned above, according to the data recording device 100, while acquiring a trigger from a lighting-up state of the blinking-type signal tower 200, the moving picture data regarding the operation state of the monitoring subject equipment in a certain period of time before and after the point of time when the abnormality in the monitoring subject equipment has been detected can be correctly recorded.

Then, according to the data recording device 100, the trigger signal can be generated by the illumination intensity sensor 50, and there is no need for a complicated element for generating the trigger signal by monitoring the operation state of the monitoring subject equipment.

Moreover, the data recording device 100 fixes the illumination intensity sensor 50 to the signal tower 200 by wrapping around the signal tower 200 by the band 52 so as to widely facilitate the operation for that.

Moreover, the data recording device 100 is detachable relative to the monitoring subject equipment by the magnet base 2.

Moreover, the data recording device 100 can arbitrarily change the photographing direction of the camera unit 3 by the flexible arm 4. Consequently, the photographing direction of the camera unit 3 can be adjusted so as to be capable of appropriately recording the moving picture data suitable for monitoring the operation state of the monitoring subject equipment.

The present embodiment can be variously modified as follows.

Instead of the magnet base 2, other well-known various fixture tools such as a clip form and the like may be provided. Moreover, without providing this kind of fixture tool 8, the control box 1 may be fixed using an adhesion material and the like. Also, the control box 1 may be placed without fixing onto the monitoring subject equipment and the like.

The camera unit 3 may be removed from the data recording device 100, so that as a data recording control device which controls the camera unit 3 as a separate member, an offer for a production, a usage, an assignment, and the like, an export, an import, or the assignment and the like may be carried out.

Instead of the flexible arm 4, an arm which cannot be bent may be provided. Alternatively, the flexible arm 4 may be omitted, so that the camera unit 3 may not be supported.

Instead of the band 52, other well-known various fixture tools such as the clip form and the like may be provided. Moreover, without providing this kind of fixture tools, the illumination intensity sensor 50 may be fixed using the adhesion material and the like.

Instead of the illumination intensity sensor 50, when an amount of the incident light is in the threshold value or above, a light sensor outputting the detecting signal may be used. In that case, it is only necessary for the controller 19 to confirm the presence or absence of the detecting signal in Step Sa2 and Step Sa19.

Data to be recorded may be various types of data such as still image data, voice data, or the like provided that the data represents the operation state of the monitoring subject equipment. Also, a number of types of data may be simultaneously recorded. The video camera 30 can be replaced by a data acquisition device such as a digital still camera, a microphone, or the like which can acquire the data to be recorded.

As for a record medium of the data, well-known various types of the record medium such as, for example, a hard disk, an optical disk, a magnet-optical disk, or the like can be substituted.

Furthermore, the present invention can be variously modified within a range that does not exceed the subject of the present invention.

The disclosure of Japanese Patent Application No. 2011-143043, filed on Jun. 28, 2011, is incorporated in the application.

While the invention has been explained with reference to the specific embodiments of the invention, the explanation is illustrative and the invention is limited only by the appended claims.

What is claimed is:

1. A data recording control device, comprising:
a sensor for detecting a light;
an output portion for outputting a trigger signal in correspondence to the sensor detecting the light with a predetermined amount of lighting or above when the output portion is set in a standby state;
a data acquisition device;
a recording device to record data acquired by the data acquisition device; and
a control portion releasing the standby state when the output portion outputs the trigger signal, and setting the output portion in the standby state in correspondence to the sensor not detecting the light with the predetermined amount of lighting or above within a predetermined period of time,
wherein the control device controls the recording device to record the data acquired by the data acquisition device from a first time point before a trigger signal is input to a second time point after the trigger signal is input, to a record medium.

2. A data recording control device according to claim 1, further comprising:
a signal tower blinking in correspondence to a detection of an abnormality in an operation of a machine; and
a fixing member fixing the sensor to the signal tower,
wherein the data acquired by the data acquisition device is data relating to an operation state of the machine.

3. A data recording control device according to claim 2, wherein the fixing member is a band capable of being wrapped around the signal tower.

4. A data recording device, comprising:
a record medium;
a data acquisition device for acquiring data from a first time point before inputting a trigger signal to a second time point after the trigger signal is input;
a recording portion for recording the data relating to an operation state of a machine acquired by the data acquisition device to the record medium;
a signal tower blinking in correspondence to a detection of an abnormality in an operation of the machine;
a sensor attached to the signal tower, for detecting a light;
an output portion for outputting the trigger signal in correspondence to the sensor detecting the light with a predetermined amount of lighting or above when the output portion is set in a standby state; and
a control portion for releasing the standby state when the output portion outputs the trigger signal, and setting the output portion in the standby state in correspondence to the sensor not detecting the light with the predetermined amount of lighting or above within a certain period of time.

5. A data recording device according to claim 4, wherein the data acquisition device is a video camera for capturing moving picture data representing the operation state of the machine, and
the recording portion records the moving picture data.

6. A data recording device according to claim 5, further comprising a support portion supporting the data acquisition device capable of changing a photographing direction thereof.

7. A data recording device according to claim 4, wherein the record medium is a semiconductor memory.

8. A data recording device according to claim 4, further comprising an enclosure housing at least the control portion, and
an attachment portion for detachably attaching the enclosure relative to the device.
